(19) United States
(12) Patent Application Publication
(10) Pub. No.: US 2006/0163484 A1
(43) Pub. Date: Jul. 27, 2006

(54) Metal halide for radiation detection, method for production thereof and radiation detector

(75) Inventors: Noboru Ichinose, Yokohama-shi (JP); Kiyoshi Shimamura, Funabashi-shi (JP); Nobuhiro Izaki, Yokohama-shi (JP); Satoshi Nakakita, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: HOKUSHIN CORPORATION

(21) Appl. No.: 11/337,734

(22) Filed: Jan. 24, 2006

(30) Foreign Application Priority Data
Jan. 27, 2005 (JP) 2005-019995
Dec. 20, 2005 (JP) 2005-365794

(51) Int. Cl. G01T 1/20; C09K 11/85

(52) U.S. Cl. 250/361 R; 252/301.4 H

(57) ABSTRACT

A metal halide for radiation detection, which is represented by the general formula Re_{A}Lu_{B}Me_{1-A-B}X_{D} where Re is at least one element among rare earth elements other than Lu, Me is at least one metallic element other than a rare earth element, X is a halogen, A+B<0.5, A≠0, B≠0, and 1≦D≦6.

### BACKGROUND OF THE INVENTION

1. Field of the Invention

This invention relates to a novel metal halide for radiation detection, a scintillator, and a radiation detector. More specifically, the invention relates to a novel metal halide for radiation detection, a scintillator, and a radiation detector which are used mainly for medical diagnostic apparatuses, such as apparatuses for X-ray computed tomography (X-ray CT), apparatuses for positron emission computed tomography (PET), and apparatuses for time-of-flight positron emission computed tomography (TOF-PET).

2. Description of the Related Art

Radiation has so far been utilized for medical diagnosis and industrial non-destructive inspection and, for example, X-ray CT apparatuses, PET apparatuses, etc. have been put to practical use as medical apparatuses. Among such apparatuses using radiation are radiation detectors for detecting radiation such as γ-rays or X-rays, for example, scintillation counter.

A scintillator is a substance which emits a visible ray or an electromagnetic wave of a wavelength close to a visible ray in response to stimulation by radiation such as γ-rays or X-rays. The scintillator is required to be high in density, short in the decay time of fluorescence, excellent in radiation resistance, and satisfactory in workability.

Bismuth germanate (Bi₄Ge₃O₁₂ single crystal (BGO)) has thus far been used as such a scintillator material for PET. However, a cerium-doped gadolinium silicate (Ce:Gd₂SiO₅ (Ce:GSO)) single crystal was developed and put to practical use with desire for high-performance characteristics (see, for example, Japanese Patent Publication No. 1987-8472 (claims)).

Then, various investigations were conducted in attempts to obtain higher performance characteristics. These investigations led to the development of cerium-doped lutetium oxylorthosilicate crystals (Ce:Lu₂SiO₅ (Ce:LSO)), which have now gone into actual use as the substances of the highest performance (see, for example, U.S. Pat. No. 4,958,080 (I CLAIM), U.S. Pat. No. 5,025,151 (WHAT IS CLAIMED IS), and Japanese Patent Application Laid-Open No. 1997-118593 (claims)).

Such rare earth orthosilicate single crystals have strong cleavage properties, may break during growth, or tend to crack when cut, so that their control during processing is very difficult.

Besides such rare earth orthosilicate single crystals, garnet crystals, such as Lu₃Al₅O₁₂ and Y₃Al₅O₁₂, are also the frequent subjects of studies on the amount of light emission and fluorescence lifetime as crystals for radiation detection (see, for example, U.S. Pat. No. 5,057,692 (Japanese Patent Publication No. 1994-7165). However, these crystals have not found practical use, because their characteristics, such as the amount of light emission and fluorescence lifetime, are markedly inferior to those of BGO, GSO and LSO which have now been used predominantly (see, for example, M. Moszynski, IEEE Trans., on Nucl., Sci., 44 (1997) 1052; A. Lempicki, IEEE Trans., on Nucl., Sci., 42 (1995) 280; and C. W. E. van Ejik, Nucl., Instr. and Meth., A460 (2001) 1).

In addition to such single crystals, various ceramic materials are investigated as scintillators, and known examples of them include polycrystalline materials (ceramics) such as BaFCl:Eu, LaOBr:Tb, CsI:Tl, CaWO₄, and CdWO₄ (CWO) (see, for example, Japanese Patent Publication No. 1984-45022 (claims)), polycrystals (ceramics) of rare earth oxides having a cubic structure, such as (Gd, Y)₂O₃: Eu (see, for example, Japanese Patent Application Laid-Open No. 1984-27283 (claims)), and polycrystals (ceramics) of rare earth sulfides, such as Gd₂O₂S:Pr (see, for example, Japanese Patent Application Laid-Open No. 1983-204088 (claims)).

Since such ceramic scintillator materials are produced by sintering powders, various proposals have been offered in connection with the improvement of transparency (translucency), the improvement of sintering properties, etc. For example, there is a proposal to increase the radiant power of a scintillator by setting the amount of impurities in a phosphor ceramic such as Gd₂O₂S:Pr, particularly, the content of a phosphate (PO₄), at 100 ppm or less (see, for example, Japanese Patent Application Laid-Open No. 1995-188655 (claims)). Another proposal is for a highly densified phosphor ceramic produced by adding a fluoride, such as LiF, Li₂GeF₆, or NaBF₄, as a sintering aid, to a rare earth sulfide powder, and sintering the resulting powder mixture by a hot isostatic press (HIP) (see, for example, Japanese Patent Publication No. 1993-016756 (claims)).

On the other hand, studies are going on for increasing the amount of light emission by changing a combination of a dopant (activator) such as CeF3, and a host material such as BaF₂ or BaLu₂F₈, and for increasing the amount of light emission by varying the proportions of the dopant and the host material. In recent years, these studies have been conducted energetically (see, for example, J. C. van't Spijker et al., Journal of Luminescence, 85, 1999, p 11-19; and M. KOBAYASHI., et al., Proc. SCINT '97, China, 1997, p 127-130)

However, there has been the problem that if the combination of the dopant and the host material is changed, even the characteristics such as light emission wavelength or fluorescence lifetime are changed. The problem has also been posed that if the proportions of the dopant and the host material are varied, the maximum amount of light emission may be smaller than the amount of light emission of BGO.

The present invention has been accomplished in the light of the above-described circumstances. It is an object of the invention to provide a metal halide for radiation detection which has a high fluorescence intensity without changing a light emission wavelength, a method for producing it, and a radiation detector.

### SUMMARY OF THE INVENTION

A first aspect of the present invention for attaining the above object is a metal halide for radiation detection, which is represented by the general formula Re_{A}Lu_{B}Me_{1-A-B}X_{D}
where Re is at least one element among rare earth elements other than Lu, Me is at least one metallic element other than a rare earth element, X is a halogen, A+B<0.5, A≠0, B≠0, and 1≦D≦6.

A second aspect of the present invention is the metal halide for radiation detection according to the first aspect, characterized in that Re is a trivalent rare earth metal other than Lu, A+B≦0.2, and 1≦D≦4.

A third aspect of the present invention is the metal halide for radiation detection according to the first aspect, characterized in that the metal halide is represented by Ce_{A}Lu_{B}Ba_{1-A-B}F₂.

A forth aspect of the present invention is the metal halide for radiation detection according to the second aspect, characterized in that the metal halide is represented by Ce_{A}Lu_{B}Ba_{1-A-B}F₂.

A fifth aspect of the present invention is a scintillator comprising the metal halide for radiation detection according to the first aspect.

A sixth aspect of the present invention is a scintillator comprising the metal halide for radiation detection according to the second aspect.

A seventh aspect of the present invention is a scintillator comprising the metal halide for radiation detection according to the third aspect.

An eighth aspect of the present invention is a scintillator comprising the metal halide for radiation detection according to the forth aspect.

A ninth aspect of the present invention is a radiation detector comprising a scintillator, which comprises the metal halide for radiation detection according to the first aspect, and a photodetector for detecting light emission from the scintillator.

A tenth aspect of the present invention is a radiation detector comprising a scintillator, which comprises the metal halide for radiation detection according to the second aspect, and a photodetector for detecting light emission from the scintillator.

A eleventh aspect of the present invention is a radiation detector comprising a scintillator, which comprises the metal halide for radiation detection according to the third aspect, and a photodetector for detecting light emission from the scintillator.

A twelfth aspect of the present invention is a radiation detector comprising a scintillator, which comprises the metal halide for radiation detection according to the forth aspect, and a photodetector for detecting light emission from the scintillator.

A thirteenth aspect of the present invention is a method for producing a metal halide for radiation detection, which is represented by the general formula Re_{A}Lu_{B}Me_{1-A-B}X_{D} where Re is at least one element among rare earth elements other than Lu, Me is at least one metallic element other than a rare earth element, X is a halogen, A+B<0.5, A≠0, B≠0, and 1≦D≦6, the method comprising the steps of:

heating Lu, Re and the metal halide to melting points or higher to form a melt or a solution; and

producing the metal halide from the melt or the solution.

The metal halide for radiation detection according to the present invention is represented by the general formula Re_{A}Lu_{B}Me_{1-A-B}X_{D} where Re is at least one element among rare earth elements other than Lu, Me is at least one metallic element other than a rare earth element, X is a halogen, A+B<0.5, A≠0, B≠0, and 1≦D≦6. However, the metal halide is preferably that in which Re is a trivalent rare earth element other than Lu, A+B≦0.2, and 1≦D≦4, and particularly preferably that represented by Ce_{A}Lu_{B}Ba_{D}F₂. No restrictions are imposed on the combination of the respective elements, nor on the composition of the elements. Moreover, the metal halide for radiation detection according to the present invention may be in any of a ceramic state, a polycrystalline state, a single crystal state, and an amorphous state, if it is transparent and has a high intensity of fluorescence. However, the crystalline state such as ceramic, polycrystal or single crystal is preferred and, needless to say, the single crystal state is particularly preferred. In the present invention, the rare earth elements are taken to include scandium Sc and yttrium Y as well as lanthanoids.

The at least one metallic element Me other than a rare earth element, and the halogen X, which constitute the metal halide serving as the host material of the metal halide for radiation detection according to the present invention, are not limited. However, examples of the metal halide are CaF₂, CaCl₂, SrCl₂, BaCl₂, BaF₂, BaBr₂, LiBaF₃, LiYF₄, LiBaF₃, K₂LaCl₅, Cs₂LiYCl₆, BaThF₆, CsY₂F₇, RbGd₂Br₇, BaY₂F₈, Hf₂CeF₁₁, Ba₄CS₃F₁₇, LiI, and LiCaAlF₆. BaF₂ and BaBr₂ are preferred, and BaF₂ is particularly preferred.

The at least one element Re among rare earth elements other than lutetium Lu, which serves as the dopant for the metal halide of the present invention, includes, for example, scandium Sc, yttrium Y, lanthanum La, cerium Ce, praseodymium Pr, neodymium Nd, samarium Sm, europium Eu, gadolinium Gd, terbium Tb, dysprosium Dy, holmium Ho, erbium Er, thulium Tm, and ytterbium Yb. Particularly, Ce is preferred. By adding the rare earth element Re as the dopant, there can be obtained an emission spectrum having a peak wavelength ascribed to the added rare earth element Re. By further adding Lu as the dopant, the amount of light emission can be increased without changing the peak wavelength of the emission spectrum. Re is preferably added to the host material, as a halide formed by binding to the same halogen as the halogen constituting the metal halide which is the host material. It is preferred to use Re which has no absorption present in the wavelength of fluorescence.

When Lu and Re are added, the intensity of fluorescence increases. Since the fluorescence lifetime may be varied, however, Re needs to be selected, as appropriate, in accordance with the desired characteristics.

The method for producing the metal halide for radiation detection according to the present invention is not limited. However, if the metal halide for radiation detection according to the present invention is used as a scintillator of a detector such as a PET or TOF-PET apparatus, it is necessary to obtain a high quality and homogeneous crystal. Examples of a crystal growth method for obtaining such a crystal are the Verneuil method, the Czochralski method (CZ method), the Bridgman method, the heat exchange method, the kyropoulos method, and the Floating Zone method (FZ method). From the viewpoint of mass producibility, the Verneuil method and the CZ method are preferred.

The metal halide for radiation detection according to the present invention can increase the fluorescence intensity without changing the light emission wavelength. Thus, a radiation detector using the metal halide for radiation detection exhibits the effect of having a high resolution.

### BRIEF DESCRIPTION OF THE DRAWINGS

The patent or application file contains at least one photograph executed in color. Copies of this patent or patent application publication with color drawing(s) will be provided by the Office upon request and payment of the necessary fee.

For a more complete understanding of the present invention and the advantages thereof, reference is now made to the following descriptions in conjunction with the accompanying drawings.

FIG. 1 is a view showing an emission spectrum appearing when a single crystal obtained in Example 1 was irradiated with gamma rays.

FIGS. 2A to 2C are light emission photographs of respective single crystals taken when these single crystals obtained in Example 1 and Comparative Examples 1 and 2 were irradiated with ultraviolet radiation.

FIG. 3 is a view showing the transmittances of the single crystals obtained in Example 1 and Comparative Examples 1 to 3.

### DESCRIPTION OF THE PREFERRED EMBODIMENTS

The metal halide for radiation detection according to the present invention will now be described in detail based on embodiments offered below. Descriptions of the present embodiments are illustrative, and the present invention is not limited to these descriptions.

To produce a metal halide crystal for radiation detection, which is an example of the metal halide for radiation detection according to the present invention, a host material such as a powdery or polycrystalline rare earth fluoride material, i.e., barium fluoride (BaF₂), and a dopant material such as lutetium fluoride (LuF₂) or cerium fluoride (CeF₃) are charged into a crucible, and the host material and the dopant material are heated to a temperature ranging from room temperature to 500 to 800° C., namely, a predetermined temperature not exceeding the melting points, while maintaining a high vacuum of the order of 10⁻⁴ to 10⁻⁵ mm Hg, in order to remove moisture and oxygen contained in a furnace and the materials. Then, a chlorofluorocarbon-based gas, such as CF₄, and an argon gas are introduced into the preparation furnace (mixing ratio, CFC-based gas: argon gas=100:0 to 0:100, volume ratio). Then, the temperature is raised to the melting points or higher to react the CFC-based gas with impurities generated on the surface of a melt or a solution and impurities present in the melt or the solution, thereby removing the impurities. A metal halide crystal for radiation detection is produced from the resulting melt or solution.

The method of producing the crystal from the thus obtained melt or solution is not limited, and includes, for example, the Verneuil method, the Czochralski method (CZ method), the Bridgman method, the heat exchange method, the kyropoulos method, and the Floating Zone method (FZ method). From the viewpoint of mass producibility, the Verneuil method and the CZ method are preferred. According to the CZ method, for example, the temperature of the melt is maintained at a temperature close to the melting point of each compound, and the seed crystal is pulled up at a rate of 0.1 to 10 mm/h while being rotated at 1 to 50 rpm, whereby a transparent, high quality single crystal having no bubbles or scattering centers in the crystal is obtained. The metal halide crystal of the present invention is characterized in that the single crystal is obtained even by slow cooling alone after melting and, if conditions are set as appropriate, the single crystal is obtained even by slow cooling without the use of the seed crystal.

The thus obtained metal halide crystal is useful as a scintillator for PET or TOF-PET.

The scintillator cut from the metal halide crystal into a predetermined size can be used as a radiation detector by combination with a photodetector corresponding to the wavelength of fluorescence generated upon absorption of radiation, for example, gamma rays, an example of the photodetector being a photodetector such as a photomultiplier tube for visible light or ultraviolet radiation.

### EXAMPLES

### Example 1

A mixture of BaF₂, CeF₃ and LuF₃ (molar ratio: 98:1:1), which were commercially available bulk ground materials with a purity of 99.99%, was charged into a crucible without being stirred. The charge was placed, unchanged, in a single crystal preparation furnace, and a vacuum of the order of 10⁻⁴ to 10⁻⁵ mmHg was drawn. In this state, the charge was heated to a temperature of about 700° C. under a vacuum to remove moisture and oxygen in the furnace and the materials. A CF₄ gas was introduced into the single crystal preparation furnace, where the materials were heated and melted in a CF₄ gas atmosphere. In this state, the system was held in a molten state for 1 hour. Impurities which appeared on the surface of the melt all vanished upon reaction with the CF₄ gas. Then, a seed crystal was brought into contact with the melt, and pulled up in a c-axis direction at a pulling-up rate of 1 mm/h and a rotational speed of 10 rpm to grow and prepare a single crystal. The prepared crystal had no bubbles, cracks or scattering centers, and was a transparent, high quality cerium-lutetium-doped barium fluoride (Ce, Lu:BaF₂) single crystal.

### Comparative Example 1

A crystal was grown in the same manner as in Example 1, except that LuF₃ was not added, and the BaF₂/CeF₃ molar ratio was set at 99:1.

### Comparative Example 2

A crystal was grown in the same manner as in Example 1, except that LuF₃ was not added, and the BaF₂/CeF₃ molar ratio was set at 95:5.

### Comparative Example 3

A crystal was grown in the same manner as in Example 1, except that CeF₃ was not added, and the BaF₂/LuF₃ molar ratio was set at 99:1.

### Test Example 1

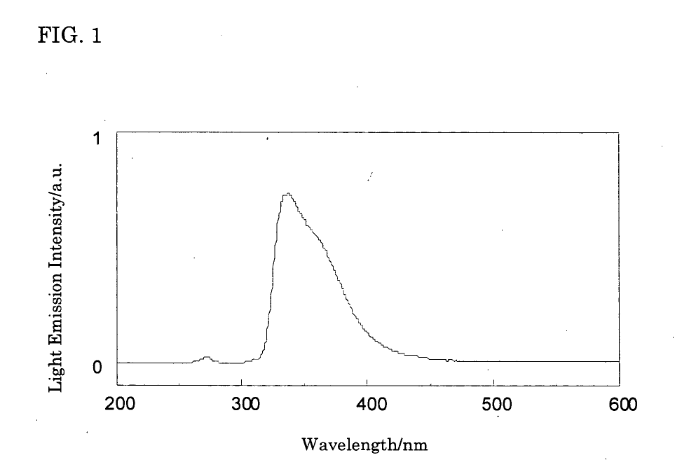

FIG. 1 shows an emission spectrum appearing when the single crystal obtained in Example 1 was irradiated with gamma rays. Table 1 shows the peak wavelength (light emission wavelength) of the emission spectrum appearing when the single crystal obtained in Example 1 to 3 was irradiated with gamma rays, and the corresponding amount of light emission standardized by the amount of light emission from the single crystal obtained in Comparative Example 1. In connection with the measurement conditions for the light emission wavelength and the amount of light emission, Cs¹³⁷ was used as a radiation source, and the light emission wavelength and the amount of light emission were measured by a photomultiplier tube (R2486, HAMAMATSU PHOTONICS K.K.).

As shown in FIG. 1, a light emission region upon the gamma ray irradiation of the single crystal obtained in Example 1 was found to be in a visible light region at 310 to 450 nm.

As shown in Table 1, it was found that the single crystal obtained in Example 1 had a light emission wavelength nearly unchanged compared with that of Comparative Example 1, but had an amount of light emission 1.4 times as large. That is, the substitution of part of Ba in the Ce:BaF₂ single crystal by Lu was found to be able to increase the amount of light emission, with the light emission wavelength being nearly unchanged. On the other hand, the single crystal obtained in Comparative Example 2, in which part of Ba in Ce:BaF₂ was further substituted by Ce, was found to be nearly unchanged in terms of the light emission wavelength, but be markedly decreased in the amount of light emission, as compared with the single crystal obtained in Comparative Example 1. Moreover, the single crystal obtained in Comparative Example 3, in which all of Ce in Ce:BaF₂ was substituted by Lu, was found to be changed in terms of the light emission wavelength, and be decreased in the amount of light emission, as compared with the single crystal obtained in Comparative Example 1.

TABLE 1

| | Light emission | Amount of light |
|---|---|---|
| | wavelength (nm) | emission (times) |
| Example 1 | 338 | 1.4 |
| Comparative | 331 | 1.0 |
| Example 1 | | |
| Comparative | 345 | 0.2 |
| Example 2 | | |
| Comparative | 308 | 0.7 |
| Example 3 | | |

### Test Example 2

Table. 2 shows the peak wavelengths (light emission wavelengths) of emission spectra appearing when the single crystals obtained in Example 1 and Comparative Example 1 were irradiated with X-rays, and the corresponding amounts of light emission standardized by the amount of light emission from the single crystal obtained in Comparative Example 1. In connection with the measurement conditions for the light emission wavelength and the amount of light emission, an X-ray tube was used as a radiation source, and the light emission wavelength and the amount of light emission were measured by a photomultiplier tube (R2486, HAMAMATSU PHOTONICS K.K.).

As shown in Table 2, it was found that the single crystal obtained in Example 1 had a light emission wavelength shifted to the long wavelength side by 25 nm in comparison with the single crystal obtained in Comparative Example 1, and had an amount of light emission 1.2 times as large. That is, the substitution of part of Ba in the Ce:BaF₂ single crystal by Lu was found to be able to increase the amount of light emission.

TABLE 2

| | Light emission | Amount of light |
|---|---|---|
| | wavelength (nm) | emission (times) |
| Example 1 | 350 | 1.2 |
| Comparative | 325 | 1.0 |
| Example 1 | | |

### Test Example 3

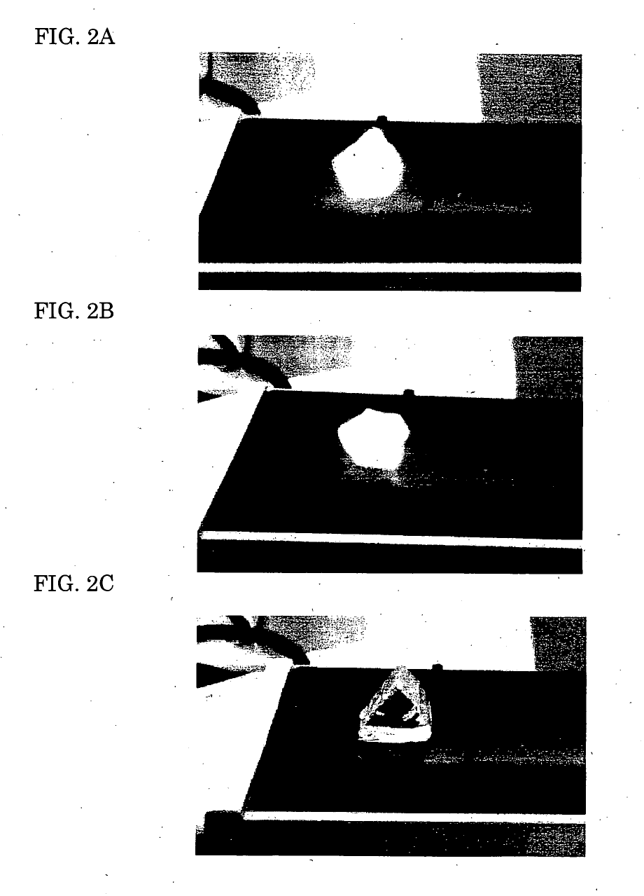

FIGS. 2A to 2C show light emission photographs of the single crystals obtained in Example 1 and Comparative Examples 1 and 2 when these single crystals were irradiated with ultraviolet radiation (wavelength 254 nm). FIG. 2A is the light emission photograph taken when the single crystal obtained in Example 1 was irradiated with ultraviolet radiation, FIG. 2B is the light emission photograph taken when the single crystal obtained in Comparative Example 1 was irradiated with ultraviolet radiation, and FIG. 2C is the light emission photograph taken when the single crystal obtained in Comparative Example 3 was irradiated with ultraviolet radiation. In connection with the measurement conditions for the light emission wavelength and the amount of light emission, an ultraviolet lamp (UVGL, Ultra-Violet Products) was used as a radiation source, and the light emission wavelength and the amount of light emission were measured by a photomultiplier tube (R2486, HAMAMATSU PHOTONICS K.K.).

As shown in FIG. 2A, it was found that a light emission region upon the ultraviolet irradiation of the single crystal obtained in Example 1 was in a visible light region, and blue light emission occurred. The single crystal obtained in Example 1 was also found to have higher luminance than the single crystals obtained in Comparative Example 1 and Comparative Example 2.

### Test Example 4

Table 3 shows the results of composition analysis, by fluorescent X-ray spectrum measurement, of the crystals obtained in Example 1 and Comparative Examples 1 to 3. PW2404 (Philips Japan Ltd.) was used as a measuring apparatus. As shown in Table 3, the resulting crystals were found to have the same blend ratio as that of the starting materials charged into the crucible.

TABLE 3

| | Composition (molar ratio) | | |
|---|---|---|---|
| | Ba | Ce | Lu |
| Example 1 | 0.98 | 0.01 | 0.01 |
| Comparative | 0.99 | 0.01 | 0.00 |
| Example 1 | | | |
| Comparative | 0.95 | 0.05 | 0.00 |
| Example 2 | | | |
| Comparative | 0.99 | 0.00 | 0.01 |
| Example 3 | | | |

### Test Example 5

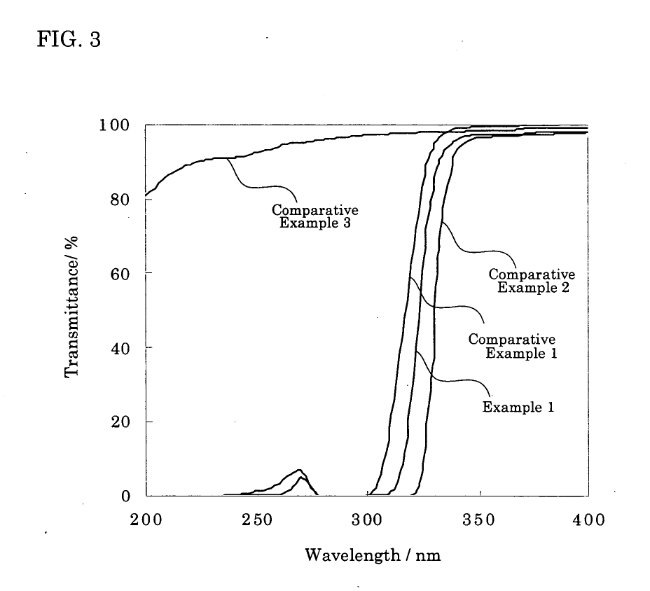

The single crystals obtained in Example 1 and Comparative Examples 1 to 3 were measured for the transmittance of light in a region at a wavelength of 200 nm to 1,100 nm. FIG. 3 shows the results of measurement of the optical transmittances of the crystals obtained in Example 1 and Comparative Examples 1 to 3 in the region at the wavelength of 200 nm to 400 nm. V570 (JASCO) was used as a measuring apparatus. The measurement results on Example 1 and Comparative Example 1 showed that when part of Ba constituting Ce:BaF₂ was substituted by Lu, the absorption edge was shifted to the long wavelength side. The measurement results on Comparative Examples 1 and 2 showed that as the amount of Ce added increased, the absorption edge was shifted to the long wavelength side. Further, the measurement results on Comparative Example 1 and Comparative Example 3 showed that when Ce constituting Ce:BaF₂ was substituted by Lu, namely, when only Lu was added as the dopant, no absorption edge was present in the region at the wavelength of 200 nm to 1,100 nm.

Although the present invention has been described in detail by the embodiments and the Examples, it should be understood that various changes, substitutions and alterations can be made therein without departing from the spirit and scope of the invention as defined by the appended claims.

What is claimed is:

1. A metal halide for radiation detection, which is represented by the general formula Re_{A}Lu_{B}Me_{1-A-B}X_{D}
where Re is at least one element among rare earth elements other than Lu, Me is at least one metallic element other than a rare earth element, X is a halogen, A+B<0.5, A≠0, B≠0, and 1≦D≦6.

2. The metal halide for radiation detection according to claim 1, wherein Re is a trivalent rare earth metal other than Lu, A+B≦0.2, and 1≦D≦4.

3. The metal halide for radiation detection according to claim 1, wherein the metal halide is represented by Ce_{A}Lu_{B}Ba_{1-A-B}F₂.

4. The metal halide for radiation detection according to claim 2, wherein the metal halide is represented by Ce_{A}Lu_{B}Ba_{1-A-B}F₂.

5. A scintillator comprising the metal halide for radiation detection according to claim 1.

6. A scintillator comprising the metal halide for radiation detection according to claim 2.

7. A scintillator comprising the metal halide for radiation detection according to claim 3.

8. A scintillator comprising the metal halide for radiation detection according to claim 4.

9. A radiation detector, comprising:
a scintillator comprising the metal halide for radiation detection according to claim 1; and
a photodetector for detecting light emission from the scintillator.

10. A radiation detector, comprising:
a scintillator comprising the metal halide for radiation detection according to claim 2; and
a photodetector for detecting light emission from the scintillator.

11. A radiation detector, comprising:
a scintillator comprising the metal halide for radiation detection according to claim 3; and
a photodetector for detecting light emission from the scintillator.

12. A radiation detector, comprising:
a scintillator comprising the metal halide for radiation detection according to claim 4; and
a photodetector for detecting light emission from the scintillator.

13. A method for producing a metal halide for radiation detection, which is represented by the general formula Re_{A}Lu_{B}Me_{1-A-B}X_{D}
where Re is at least one element among rare earth elements other than Lu, Me is at least one metallic element other than a rare earth element, X is a halogen, A+B≦0.5, A≠0, B≠0, and 1≦D≦6,
the method comprising the steps of:
heating Lu, Re and the metal halide to melting points or higher to form a melt or a solution; and
producing the metal halide from the melt or the solution.
